(19) United States
(12) Patent Application Publication
(10) Pub. No.: US 2002/0143423 A1
(43) Pub. Date: Oct. 3, 2002

(54) Scheduling system for an electronics manufacturing plant

(76) Inventors: Robert Huber, Duluth, GA (US); Vern Harrison, Bellevue (CA)

Correspondence Address: Elsa Keller, Legal Assistant, Intellectual Property Department, SIEMENS CORPORATION, 186 Wood Avenue South, Iselin, NJ, 08830, US

(21) Appl. No.: 09/824,665

(22) Filed: Apr. 3, 2001

Related U.S. Application Data
(60) Provisional application No. 60/216,285, filed on Jul. 6, 2000.

(51) Int. Cl. G06F 19/00

(52) U.S. Cl. 700/121

(57) ABSTRACT

A system for assisting operators in electronics manufacturing plants includes a processor, a data storage device coupled to the processor, and a display coupled to the processor, the processor configured to run monitoring software stored in the data storage device and adapted for being run on the processor. The system includes at least one monitoring device, such as a circuit panel magazine feeder monitoring device, a screen printer monitoring device, a component placement machine monitoring device, an oven monitoring device, or a magazine storage monitor device. An assembly line is also disclosed, as is a handheld device for an operator. Also provided is a method for operating an electronics assembly line comprising the steps of monitoring at least two of a screen printer, a first placement machine and a second placement machine so as to generate electronic task data, organizing the task data so as to form a list of tasks, and displaying the list of tasks.

### CROSS-REFERENCE TO RELATED APPLICATIONS

The present application claims priority from U.S. Provisional Patent Application No. 60/216,285, filed Jul. 6, 2000, entitled OPERATORS KIT, which application is hereby incorporated by reference herein.

### BACKGROUND OF THE INVENTION

1. Field of the Invention

The present invention relates generally to assembly lines and more particularly to a task scheduling system for various tasks related to an assembly line.

2. Background Information

In the field of electronics manufacturing, an operator may oversee an assembly line in a plant to ensure smooth operation by performing various tasks, such as providing supplies to devices on the assembly line, supplying of components, splicing of component tapes, etc. Typically, the operator spends one third of the time actually performing tasks, another third of their time scheduling the next or future tasks and the last third without any scheduled tasks, i.e. reserve time. This reserve time is necessary as a buffer because it is not known what problems may arise on the assembly line. For example, a high priority problem may arise which could bring the assembly line to a halt. Such a problem requires immediate attention so that other tasks are assigned a lower priority and put off to a later time.

Because the operator is often tending to known problems or tasks, the operator may be distracted from those conditions that are more urgent but not yet apparent. Therefore, the operator often is far away from the next necessary task, addressing an issue that is not the greatest priority. The operator is usually not aware of developing problems as well, such as the depletion of a certain part or material. As a result, assembly line interruptions for stoppages are numerous, time-consuming and usually performed in the wrong order, severely affecting efficiency. The operator usually relies on personal investigation of the line to determine which problems should be handled and in what order.

U.S. Pat. No. 6,032,788 purports to disclose an assembly line for printed circuit boards including a screen printing machine, a handling and placement machine and a reflow oven. A rail system moves the printed circuit boards between the various components. No system appears to be provided for addressing how problems on the assembly line are to be handled.

### SUMMARY OF THE INVENTION

The present invention provides a system for assisting operators in electronics manufacturing plants, the system comprising a processor, a data storage device coupled to the processor, a display coupled to the processor, monitoring software stored in the data storage device and adapted for being run on the processor, and at least one of a circuit panel magazine feeder monitoring device, a screen printer monitoring device, a component placement machine monitoring device, an oven monitoring device, an inspection machine monitoring device and a magazine storage monitoring device.

The tasks for the operator advantageously can be arranged by the processor, for example as a function of time, and displayed so as to permit the operator to organize his time more efficiently.

The placement machine monitoring device may include a splice detection subsystem and closed-loop component validation subsystem.

A network, preferably a wireless LAN, connects the processor and the monitoring devices. The display advantageously may be part of a handheld device for the operator.

The present invention also provides a method of operating an electronic manufacturing plant comprising the steps of providing the system to at least one operator and permitting the operator to operate the plant using, at least in part, the system. The present invention also provides an electronics device manufactured according to the method.

The operator advantageously may be alerted, for example through a beeper, when a preselected limit of the monitoring software is reached.

Also provided by the present invention is a printed circuit board assembly line comprising a screen printer having a screen printer monitoring device for sensing a solder level at the screen printer, at least one component placement machine having a feed tape and a placement monitor for monitoring at least one of the existence of a feed tape splice and the number of components on the feed tape. A conveyor may be located at least between the screen printer and the at least one component placement machine for transporting circuit boards. A processor receives data from the screen printer monitoring device and the placement monitor. A network, for example a LAN, is operable between the placement monitor and the processor.

The present invention further provides a method for manufacturing a printed circuit board comprising the steps of screen printing a printed circuit board with a screen printer, placing at least one component on the printed circuit board using a placement machine, monitoring at least one of the screen printer and the placement machine so as to generate data relating to necessary operator tasks, and displaying the data to the operator, as well as a method for operating an electronics assembly line comprising the steps of monitoring at least two of a screen printer, a first placement machine and a second placement machine so as to generate electronic task data, organizing the task data so as to form a list of tasks, and displaying the list of tasks.

A handheld device is provided comprising a processor operatively connected to receive data from at least one of a screen printer and a component placement machine and a display connected to the processor displaying task data related to the screen printer and the component placement machine.

The handheld device advantageously may further include a barcode scanner for scanning component tapes.

The operator thus can hold the handheld device and move about the assembly line while still be informed of the next necessary tasks and any emergencies.

A method for scheduling tasks on an assembly line provides the steps of receiving input data from at least two of a screen printer, a first component placement machine and a second component placement machine, determining a first task time as a function of the input data, determining a second task time as a function of the input data, and displaying both the first task time and the second task time.

Advantageously, the operator thus can see the next necessary tasks in proper time order.

### BRIEF DESCRIPTION OF THE DRAWINGS

A preferred embodiment of the present invention is described below by reference to the following drawings in which:

FIG. 1 shows an electronics manufacturing assembly line with an automated and integrated maintenance scheduling system according to the present invention;

FIG. 2 shows a display of the handheld device of FIG. 1; and

FIG. 3 shows a flowchart of a method according to the present invention.

### DETAILED DESCRIPTION

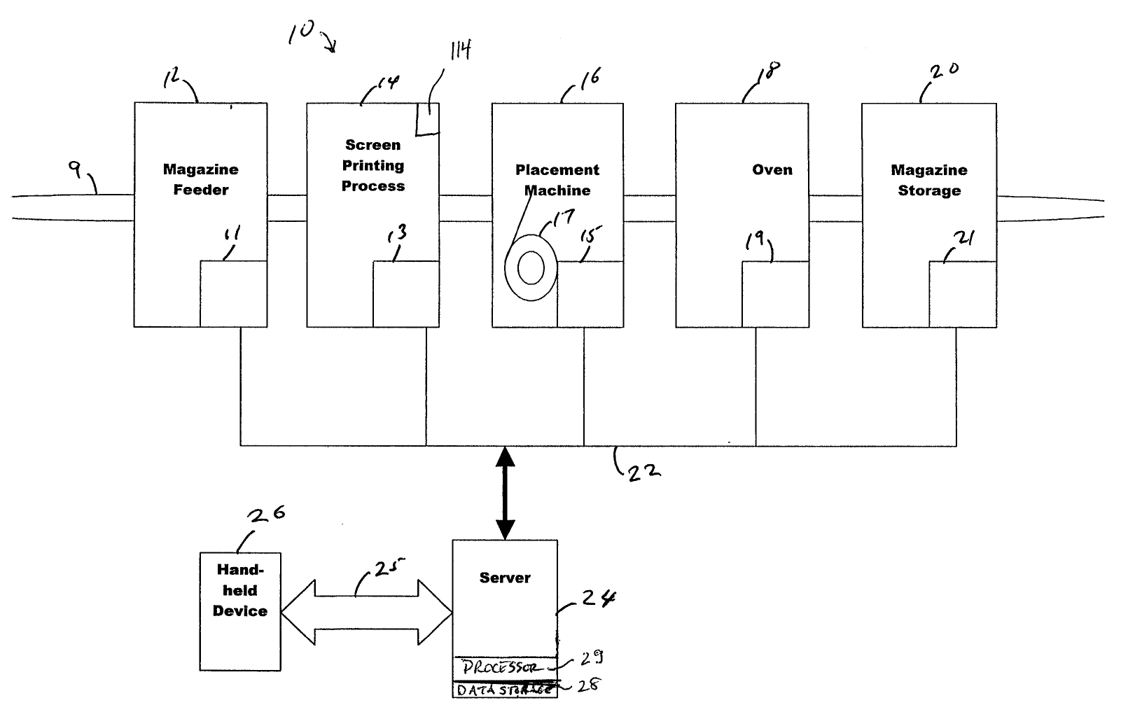

FIG. 1 shows an assembly line 10 with a monitoring and scheduling system according to the present invention for circuit board manufacturing. A conveyor belt 9 can carry circuit boards along the assembly line 10. An input conveyance component 12, in this case a magazine feeder, feeds circuit boards onto the belt 9 from a plurality of magazines, each of which can contain, for example, twenty blank circuit boards. A magazine fill monitor 11 can monitor the number of full magazines of the magazine feeder, as well as the time the last full magazine is accessed.

The conveyor belt 9 carries the boards to a screen printer 14, which applies solder to the circuit boards. The screen printer 14 has a solder refill device 114, where an operator can add more solder when the solder for the screen printer falls below a certain level. The screen printer 14 also has a solder amount meter 13 for monitoring an amount of solder present in screen printer 14.

The conveyor belt 9 then transports the printed boards to a placement machine 16, also known as a pick and place machine, for placement of electronic components such as capacitors onto the printed circuit boards. The placement machine 16 includes a reel tape feeding device 17 for feeding components on reels of tape to a placement arm of the placement machine. Each reel may include for example 5,000 or 10,000 components such as capacitors. A tape will run out after a certain amount of time depending upon the component usage and the placement machine speed, for example after 15 minutes. The operator then preferably places a new tape of components on a splicing device, which splices a new tape onto the end of the old tape on the reel, so that the placement machine 16 can operate continuously. Alternately, but not preferably, the operator can stop the assembly line 10 when the old tape has almost run out, and then place a new tape on reel 17. Circuit board assembly lines using component tape reels thus have required constant monitoring of tape levels and component availability by operators, who often need to monitor several placement machines. Morever, a single placement machine may have more than one feeder reels, so that several tapes are being fed at the same time at a single machine.

For each reel 17 of each placement machine, the assembly line 10 includes a tape monitor device 15 for monitoring the amount of tape or components remaining on the reel and for detecting a splice.

After the placement machine(s) 16 place the components on the printed circuit boards, the boards are heated in an oven 18 and then transferred to a magazine storage unit 20. The oven temperature can be monitored by a temperature monitor 19, and the remaining capacity of the storage unit 20 can be monitored by a storage monitor 21.

Monitoring software of the present system may reside in a data storage device 28 of a server 24, which is connected via a LAN 22 to monitors 11, 13, 15, 19, 21. LAN 22 may be a fixed cable LAN, for example a 10/100 ETHERNET connection, or may be a wireless LAN. The server 24 has a processor 25, for example a processor commercially available from the Intel Corporation, which can receive inputs from the monitors 11, 13, 15, 19 and 21 and process the monitor data using the monitoring software.

Monitors 11, 13, 15, 19, and 21 also can send error messages, for example, if fiducials on the circuit boards are not properly recognized.

A handheld device 26 having a processor 33 can interface, preferably through a wireless connection 25, with the server. The operator holds the handheld device 26, which may be a portable computing device such as POCKET PC or PALM PILOT with a display and wireless LAN connectivity. Preferably, the handheld device also has paging or alarm capability and bar code scanning capability.

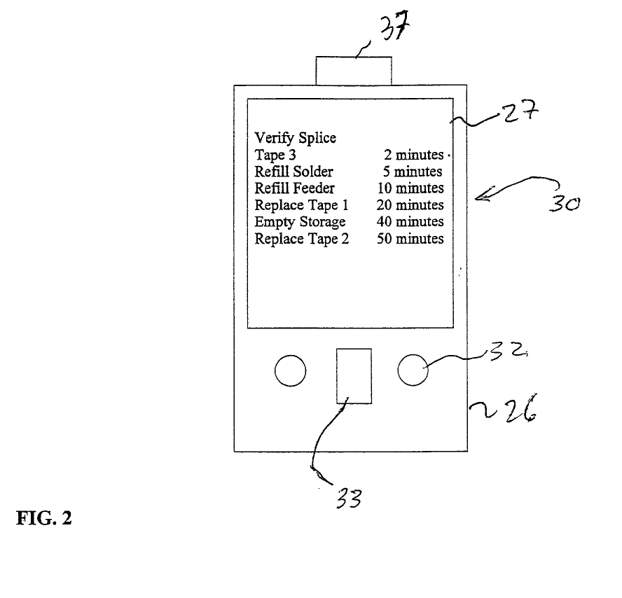

As shown in FIG. 2, the handheld device 26 has a display 27 for scheduling the next operations to be performed by the operator. The schedule is downloaded onto the handheld device 26 for display to the assembly line operator, thereby eliminating the need for the operator to run along the line 10 to see what tasks should be performed next and the need to schedule maintenance tasks. The maintenance scheduling process is effectively automated.

An example of a schedule 30 is shown on display 27. Schedule 30 indicates that in 2 minutes a splice must be verified for the third placement machine. This verification is performed by having the operator sweep a barcode reader 32 over a barcode on the new tape, thus identifying the new tape and the components to make sure they are the desired components for that placement machine. The schedule states that solder for the screen printer must be refilled within five minutes, that in 10 minutes an new blank board magazine in feeder 12 must be provided, that in 20 minutes a new tape must be provided for splicing into first placement machine reel 17, that in forty minutes an empty printed circuit board magazine must be added to storage unit 20, and that in fifty minutes a new component tape for a second placement machine must be provided. The device 26 can provide an alarm or beeping sound when an action is to be performed within a certain time, for example, five minutes. The user can use buttons 32 on the device 26 obtain more details or scroll through the tasks.

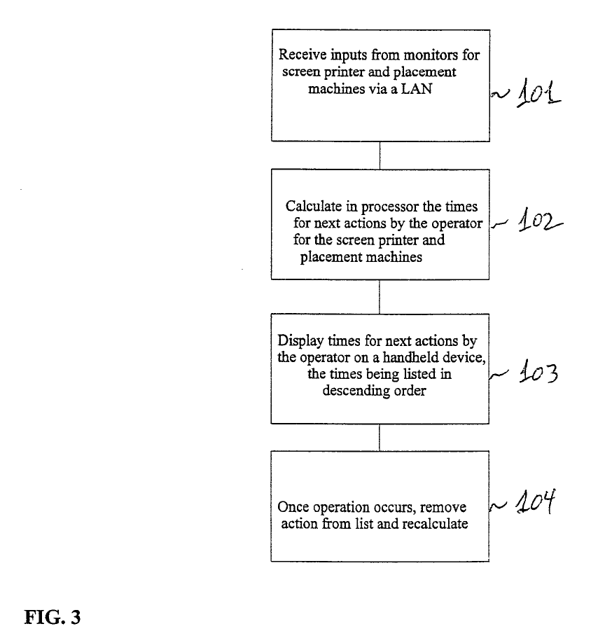

FIG. 3 shows a preferred method for the software on server 24 for monitoring and scheduling the tasks of the operator of the assembly line 10. In step 101, the server 24 can be provided with input data from monitors 11, 13, 15, 19 and 21. The server can also receive information on a predetermined or actual speed of the conveyor belt 9. The delivery rate of the magazine feeder 12 can be calculated or set, so that, for example, 5 circuit boards per minute are to be delivered to the conveyor belt. In step 102, the server 24 calculates time before the magazine feeder 12 needs to be refilled based on the delivery rate and the number of full magazines present.

For example, the magazine feeder 12 can hold fifteen magazines of twenty circuit boards each, and the monitor 11 can determine the number of full magazines in the feeder 12. The magazine monitor 11 thus can send a signal indicating the number of full magazines in the feeder. The amount of time before the a new magazine needs to be added can be estimated by the server 24 by the formula: minutes to refill=(20 boards/5 boards per minutes)*number of full magazines. In addition, the exact number of minutes remaining can be calculated by using a timer which starts when a full magazine is first accessed. The formula then used is: minutes to refill=(20 boards/5 boards per minute)*number of full magazines+(20 boards/5 boards per minute−the timer time). The timer is reset to zero every time a new full magazine is accessed.

Also in step 102, the server 24 can determine the solder fill level through monitor 13. The time to refill the solder can be calculated based on the volume of solder present and the flow rate of the solder. For example, a first fill level F(0) can be calculated at time zero, and a second fill level F(1) can be calculated after one minute, and at each minute T thereafter. The time remaining TR before a solder refill is necessary can then be estimated after a set time period (dT), for example one minute, by the server 24 as follows: the present volume F(1) divided by the flow rate (F(0)−F(1)/dT), and at every minute T thereafter as F(T)/((F(T−dT)−F(T))/dT)). Thus if after ten minutes 2 liters of solder remain and after nine minutes 2.1 liters of solder were present, the time remaining would be estimated as 2 liters/((2.1 liters−2 liters)/1 minute) or 20 minutes.

The server 24 also can determine in step 102 a tape fill level through monitor 15 by receiving information on the initial amount of components on a tape roll, counting the number of picked-up components and determining a placement rate. Thus if a tape has 5000 components which are being placed at a rate of 100 per minute, fifty minutes remain before a splice is required. The initial amount of components can be provided by barcode information on the tape.

The monitor 19 can provide continual temperature measurements. Only if a certain temperature boundary, either too hot or too cold, is passed will an alarm be sent by the server 24 to the handheld device 26.

Monitor 20 can monitor the number of empty cartridges available to be filled, and the rate of the receipt of the finished circuit boards, so that the time can be estimated for when a new empty cartridge or cartridges must be added.

In step 103, the server then can provide on screen 27 of the handheld device 26 a listing of the next necessary operations for the operator, starting with the operation which must be performed next.

In step 104, after the operation is performed, the specific monitor device senses the new time requirement, for example a new tape has been spliced, and provides that data to the server so that a new screen can be generated with the new time requirements. Since the server is continuously receiving data from the monitors, the screen can be updated instantaneously.

The paging capability in the handheld device 26 alerts operators when a certain operation is about to become necessary, for example when an operation must be performed within ten minutes. The paging capability also can alert the operator when an emergency condition arises and its cause, such as a tape break or the line has stopped or a fiducial has not been read. Response time is markedly improved because the operator does not have to investigate to determine the reason for stoppage since they are advised of the exact cause immediately. Reminders can be set by the system for certain times causing the operator to be paged accordingly.

Other additional attributes about the process can be alerted to the operator, based on predefined limits of production parameters, and machine settings. Should a predefined situation or limit be exceeded, or satisfied, the operator is advised of the situation via device 26. The proper steps and tools to remedy the situation will be provided to the operator on the pocket PC to correct this situation. Entry of data by the operator also may be required via buttons 32. This may include prescribed procedures that will be available, when the operator encounters this situation or additional tools that they must interact with.

The handheld device 26 also can have barcode reader 37 as shown in FIG. 2, for example to ensure or identify that the correct component reel is on the right feeder at the right time. The barcode reader thus can identify a component reel, and from a database accessible by the server the initial number of components on the reel can be determined as a function of the barcode. Also the type of components can be ascertained through the database to ensure that the proper components are being fed to the placement machine 16. For a closed loop system with an automatic splicer, verification should only be done after a splice is detected by monitor 15. The operator then has a certain amount of time to verify the barcode on the spliced reel. The sensor 15 thus can inform the operator that an automated splice has occurred and that the operator has to verify the barcode by telling him/her on which machine and which track the verification must occur.

Both server 24 and handheld device 26 have processors with an accessible memory or data storage device.

The monitoring devices 11, 13, 15, 19 and 21 can operate with a realtime operating system (RTOS) such as VXWorks from Wind RiverSystems. The handheld device, if wireless, can communicate with the server for example using a cellular telephone modem, a wireless LAN, an infrared connection or other wireless standard. The LAN 22 may also be wireless.

“Monitoring devices” as defined herein are any device including at least one sensor or detector.

The present invention can also include other types of monitoring devices, such as that for inspection or test equipment.

Moreover, the task scheduling system could be used to schedule other tasks unrelated to the actual monitoring devices of the assembly line, such as ordering new supplies, cleaning of a factory, stocking parts, etc.

What is claimed is:

1. A system for assisting operators in electronics manufacturing plants, the system comprising:
a processor;
a data storage device coupled to the processor;
a display coupled to the processor;
monitoring software stored in the data storage device and adapted for being run on the processor; and
at least one of a circuit panel magazine feeder monitoring device, a screen printer monitoring device, a component placement machine monitoring device, an oven monitoring device, and a magazine storage monitor device.

2. The system as recited in claim 1 wherein the system includes the screen printer monitoring device and the component placement machine monitoring device.

3. The system as recited in claim 1 wherein the component placement machine monitoring device includes a splice detection subsystem and component closed-loop validation subsystem.

4. The system as recited in claim 1 further comprising a network connecting the processor and said at least one monitoring device.

5. The system as recited in claim 4 wherein the network is a wireless LAN.

6. The system as recited in claim 1 wherein the display is part of a handheld device.

7. The system as recited in claim 6 wherein the processor is part of the handheld device.

8. The system as recited in claim 6 wherein the processor is located on a stationary server, the server being coupled to the handheld device in a wireless fashion.

9. A method of operating an electronic manufacturing plant comprising the steps of
providing a system to at least one operator, the system comprising a processor; a data storage device coupled to the processor; a display coupled to the processor; the processor configured to run monitoring software stored in the data storage device; monitoring software stored in the data storage device and adapted for being run on the processor; and at least one of a circuit panel magazine feeder monitoring device, a screen printer monitoring device, a component placement machine monitoring device and a magazine storage monitor device; and
permitting the operator to operate the plant using, at least in part, the system.

10. The method as recited in claim 9 further comprising alerting the operator when a preselected limit of the monitoring software is reached.

11. An electronics device manufactured according to the method of claim 9.

12. A printed circuit board assembly line comprising:
a screen printer having a screen printer monitoring device for sensing a solder level at the screen printer;
at least one component placement machine having a feed tape and a placement monitor for monitoring at least one of the existence of a feed tape splice and the number of components on the feed tape; and
a processor receiving data from the screen printer monitoring device and the placement monitor.

13. The printed circuit board assembly line as recited in claim 12 further comprising a conveyor located at least between the screen printer and the at least one component placement machine for transporting circuit boards.

14. The printed circuit board assembly line as recited in claim 12 further comprising a network between the placement monitor and the processor.

15. The printed circuit board assembly line as recited in claim 12 further comprising a display for displaying information as a function of the data.

16. The printed circuit board assembly line as recited in claim 15 wherein the display is on a handheld device.

17. The printed circuit board assembly line as recited in claim 16 wherein the handheld device includes a barcode scanner.

18. The printed circuit board assembly line as recited in claim 12 further comprising a magazine feeder having a magazine feeder monitor, the processor receiving data from

19. A method for manufacturing a printed circuit board comprising the steps of
screen printing a printed circuit board with a screen printer;
placing at least one component on the printed circuit board using a placement machine;
monitoring at least one of the screen printer and the placement machine so as to generate data relating to necessary operator tasks; and
displaying the data to the operator.

20. The method as recited in claim 19 further comprising organizing the data as a function of time.

21. The method as recited in claim 19 wherein more than one placement machine is monitored.

22. The method as recited in claim 19 wherein the data is displayed to a handheld device.

23. The method as recited in claim 19 further comprising sweeping a component tape with a barcode reader.

24. A printed circuit board manufactured according to the method of claim 19.

25. A method for operating an electronics assembly line comprising the steps of:
monitoring at least two of a screen printer, a first placement machine and a second placement machine so as to generate electronic task data;
organizing the task data so as to form a list of tasks; and
displaying the list of tasks.

26. The method as recited in claim 25 further comprising monitoring the assembly line for malfunctions and displaying malfunction data together with the list of tasks.

27. The method as recited in claim 26 wherein the malfunction data includes data indicating at least one of a fiducial misreading, an assembly line conveyor stop, and a failed splice.

28. A handheld device comprising:
a processor operatively connected to receive data from at least one of a screen printer and a component placement machine; and
a display connected to the processor displaying task data related to the screen printer and the component placement machine.

29. The handheld device as recited in claim 28 further comprising a barcode scanner.

30. A method for scheduling tasks on an assembly line comprising:
receiving input data from at least two of a screen printer, a first component placement machine and a second component placement machine;
determining a first task time as a function of the input data;
determining a second task time as a function of the input data; and
displaying both the first task time and the second task time.

31. Executable process steps operative to control a processor, stored on a processor readable medium, for monitoring an assembly line to schedule maintenance, the steps comprising:
receiving input data from at least two of a screen printer, a first component placement machine and a second component placement machine;
determining a first task time as a function of the input data;
determining a second task time as a function of the input data; and
displaying both the first task time and the second task time.
